(19) United States
(12) Patent Application Publication
(10) Pub. No.: US 2016/0098289 A1
(43) Pub. Date: Apr. 7, 2016

(54) SYSTEM AND METHOD FOR HANDLING AN INTERRUPT

(71) Applicant: ELECTRONICS AND TELECOMMUNICATIONS RESEARCH INSTITUTE, Daejeon (KR)

(72) Inventors: Dong Hyouk LIM, Daejeon (KR); Tae Ho KIM, Gunpo-si (KR); Chae Deok LIM, Daejeon (KR)

(21) Appl. No.: 14/538,916

(22) Filed: Nov. 12, 2014

(30) Foreign Application Priority Data
Oct. 2, 2014 (KR) 10-2014-0133041

(51) Int. Cl. G06F 9/455; G06F 9/48

(52) U.S. Cl. CPC G06F 9/45558; G06F 9/4812; G06F 2009/45579

(57) ABSTRACT

An interrupt controller, a system and a method for handling an interrupt under a virtualization environment are provided. The system for handling an interrupt, includes: an interrupt controller, a virtual machine, and a hypervisor which controls activation of the virtual machine, the interrupt controller may receive a physical interrupt from the outside and transmit the physical interrupt to the hypervisor or the virtual machine based on a characteristic of the physical interrupt, the hypervisor may convert the physical interrupt into a virtual interrupt to transmit the virtual interrupt to the virtual machine, and the virtual machine may handle the physical interrupt or the virtual interrupt using a first interrupt handler which is included in the virtual machine.

### CROSS-REFERENCE TO RELATED APPLICATIONS

This application claims priority to and the benefit of Korean Patent Application No. 10-2014-0133041 filed in the Korean Intellectual Property Office on Oct. 2, 2014, the entire contents of which are incorporated herein by reference.

### TECHNICAL FIELD

The present invention relates to a system and a method for handling an interrupt, and more particularly, to a system and a method for handling an interrupt under a virtualization environment.

### BACKGROUND ART

A virtualization technology is a technology which provides a virtual hardware to an operating system through a logical hierarchy. Specifically, an object of the virtualization technology is to use a plurality of operating systems in a single hardware. The virtualization technology is getting the spotlight due to a recent trend of using a multicore microprocessor.

In the meantime, a hardware supported virtualization technology may be viewed from three aspects of virtualization of a central processing unit (CPU), virtualization of a memory, and virtualization of an interrupt. Among these, the virtualization of an interrupt is the closest to the performance. The virtualization of an interrupt is related with input/output and a degraded performance due to the virtualization of an interrupt becomes a main cause of lowering utilization of a virtual environment. Specifically, when the interrupt is virtualized in order to virtualize the hardware, processing by the hypervisor is frequently required, which may increase an overhead of a performance.

### SUMMARY OF THE INVENTION

The present invention has been made in an effort to provide a system and a method for handling (or processing) an interrupt which may reasonably reduce an intervention of a hypervisor to improve a performance of a hardware, specifically, an input/output performance.

According to an exemplary embodiment of the present invention, a system for handling an interrupt may comprise an interrupt controller, a virtual machine, and a hypervisor which controls activation of the virtual machine, the interrupt controller may receive a physical interrupt from the outside and transmit the physical interrupt to the hypervisor or the virtual machine based on a characteristic of the physical interrupt, the hypervisor may convert the physical interrupt into a virtual interrupt to transmit the virtual interrupt to the virtual machine, and the virtual machine may handle the physical interrupt or the virtual interrupt using a first interrupt handler which is included in the virtual machine.

According to an exemplary embodiment of the present invention, the interrupt controller may transmit the physical interrupt to the hypervisor or the virtual machine depending on whether the physical interrupt requires an intervention of the hypervisor.

According to an exemplary embodiment of the present invention, the interrupt controller may represent whether the physical interrupt requires an intervention of the hypervisor using an interrupt request (IRQ)_MODE which is included in the physical interrupt.

According to an exemplary embodiment of the present invention, the hypervisor may handle the physical interrupt using a second interrupt handler.

According to an exemplary embodiment of the present invention, the interrupt controller may comprise an end of interrupt register and when the handling of the virtual interrupt is completed, the virtual machine may write information of completion in the end of interrupt register.

According to an exemplary embodiment of the present invention, when the information of completion is written in the end of interrupt register, the interrupt controller may transmit a maintenance interrupt to the hypervisor.

According to an exemplary embodiment of the present invention, the interrupt controller includes a virtual machine identifier register, when the virtual machine is activated by the hypervisor, the virtual machine writes the virtual machine ID of the virtual machine in the virtual machine ID register, and the interrupt controller may transmit the physical interrupt to the virtual machine whose virtual machine ID is written.

According to an exemplary embodiment of the present invention, a plurality of virtual machines may be provided and the interrupt controller may further include an enable/disable register (E/D register) storing information on interrupts which can be handled by the plurality of virtual machines and transmit the received physical interrupt to a virtual machine which is capable of handling the received physical interrupt based on information which is included in the E/D register.

According to an exemplary embodiment of the present invention, the hypervisor may switch the plurality of virtual machines in a predetermined order to be active, the interrupt controller may comprise a virtual machine ID register, the virtual machine which is switched to be active may write its own virtual machine ID in the virtual machine ID register, and the interrupt controller may transmit the received physical interrupt to a virtual machine which is capable of handling the received physical interrupt and whose virtual machine ID is written.

According to an exemplary embodiment of the present invention, when a virtual machine which is capable of handling the received physical interrupt and whose virtual machine ID is written is handling other physical interrupt or other virtual interrupt, the interrupt controller may queue the received physical interrupt.

According to the interrupt controller, the system and the method for handling an interrupt of the present invention, not all the received physical interrupts are transmitted to the hypervisor so that intervention of the hypervisor may be reduced. Even at the time of ending the interrupt handling, the maintenance interrupt is generated in the interrupt controller only when the handling of the virtual interrupt is completed, so that the intervention of the hypervisor may be further reduced. By doing this, the intervention of the hypervisor may be reasonably reduced so that a performance of a hardware, especially, an input/output performance may be improved.

### BRIEF DESCRIPTION OF THE DRAWINGS

FIG. 1 illustrates a general handling procedure of an interrupt under a virtualization environment.

FIG. 2A illustrates a system for handling an interrupt at the time of interrupt handling according to a first exemplary embodiment of the present invention.

FIG. 2B illustrates a system for handling an interrupt when an interrupt handling ends according to a second exemplary embodiment of the present invention.

FIG. 3 illustrates a method for handling an interrupt according to a first exemplary embodiment of the present invention.

FIG. 4 illustrates a system for handling an interrupt at the time of interrupt handling according to a second exemplary embodiment of the present invention.

FIG. 5 illustrates a method for handling an interrupt according to a second exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to accompanying drawings, but the present invention is not limited or restricted by the exemplary embodiments. The same reference numeral denotes a substantially same component and the contents illustrated in other drawings may be referred under this rules. Further, contents which are determined to be obvious to those skilled in the art or repeated contents may be omitted.

### [General Handling Procedure of an Interrupt]

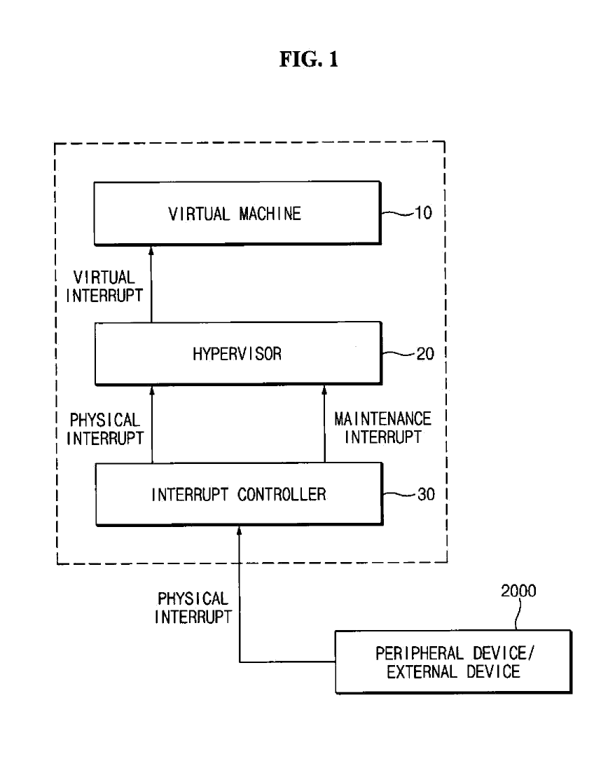

FIG. 1 illustrates a general handling procedure of an interrupt under a virtualization environment.

Referring to FIG. 1, a physical interrupt is transmitted from a peripheral device/external device 2000 to an interrupt controller 10. Next, the interrupt controller 10 transmits the received physical interrupt to a hypervisor 20. When the received physical interrupt is related with the hypervisor 20, the hypervisor 20 drives the interrupt using an interrupt handler which is an internal function of the hypervisor 20 to perform a handling routine of the physical interrupt. In contrast, when the received physical interrupt is related with a virtual machine 30, the hypervisor 20 converts the physical interrupt into a virtual interrupt to generate a virtual interrupt and transmit the generated virtual interrupt to a virtual machine 30.

Thereafter, the virtual machine 30 uses an interrupt handler, which is provided in the virtual machine, corresponding to the received virtual interrupt to perform an interrupt handling routine. When the interrupt handling is completed, the virtual machine 30 issues notification indicating that the interrupt handling is completed, to the interrupt controller 10. The interrupt controller 10, which receives the notification indicating that the interrupt handling is completed, generates a maintenance interrupt and transmits the maintenance interrupt to the hypervisor 20. By doing this, the interrupt handling procedure in the virtual machine 30 ends.

Even though such a general interrupt handling procedure provides a function which supports a virtualization environment, the hypervisor 20 needs to intervene in all physical interrupts in order to allow the virtual machine 30 to handle a physical interrupt which is transmitted from the peripheral device/external device 2000 or end the handling. In other words, since the hypervisor 20 receives all physical interrupts which are transmitted from the interrupt controller 10 and the maintenance interrupt from the interrupt controller 10, the hypervisor 200 intervenes in the handling of one interrupt two times.

However, if the hypervisor 20 frequently intervenes, overhead in the performance of the hardware is increased, which may adversely affect the actual virtualization of a hardware.

### First Exemplary Embodiment

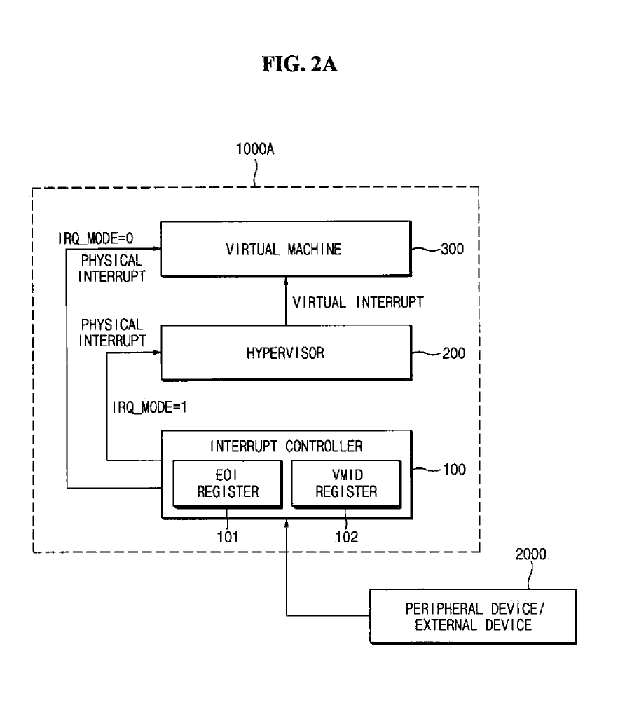

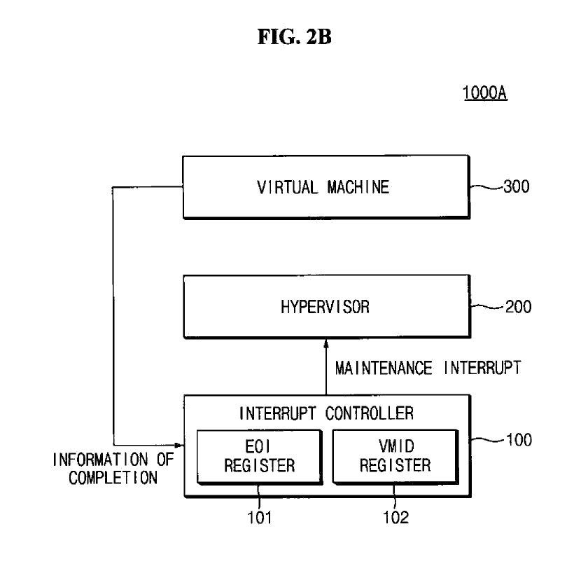

FIG. 2A illustrates a system 1000A for handling an interrupt at the time of handling interrupt according to a first exemplary embodiment of the present invention.

Referring to FIG. 2A, the system 1000A according to a first exemplary embodiment of the present invention may comprise an interrupt controller 100, a hypervisor 200, and a virtual machine 300. In the meantime, a peripheral device/external device 2000 is illustrated in order to generate an interrupt and transmit the interrupt to the system 1000A. Further, it is assumed that the interrupt from the peripheral device/external device 2000 is a physical interrupt which can be handled (or processed) by the virtual machine 300.

The interrupt controller 100 receives a physical interrupt from the peripheral device/external device 2000 and determines an entry mode of an interrupt depending on a characteristic of the physical interrupt. In this case, the entry mode of the interrupt may be represented, for example, by one bit of IRQ_MODE which is included in an interrupt request IRQ.

In other words, in the case of a physical interrupt which does not require an intervention of the hypervisor 200 in accordance with the characteristic of the physical interrupt, the interrupt controller 100 may set the entry mode of the interrupt, that is, bit of IRQ_MODE, to zero. The interrupt controller 100 may transmit a physical interrupt having zero bit of IRQ_MODE to the virtual machine 300.

In contrast, in the case of a physical interrupt which requires an intervention of the hypervisor 200 in accordance with the characteristic of the physical interrupt, the interrupt controller 100 may set the entry mode of the interrupt, that is, bit of IRQ_MODE, to one. The interrupt controller 100 may transmit a physical interrupt having one bit of IRQ_MODE to the hypervisor 200.

In summary, IRQ_MODE bit=0 (virtual machine) and 1 (hypervisor).

The interrupt controller 100 may comprise an end of interrupt register (EOI register) 101 and a virtual machine identifier register (VMID register) 102. Further, even though not illustrated, the interrupt controller 100 may further include a configuration which is required to operate the interrupt controller 100 as an interrupt controller.

Information of completion by the virtual machine 300 is written in the EOI register 101. The information of completion may be an IRQ number of the handled interrupt. When the information of completion from the virtual machine 300 is written in the EOI register 101, the interrupt controller 100 may generate a maintenance interrupt in order to end the handling of the interrupt of the virtual machine 300. The interrupt controller 100 may transmit the maintenance interrupt to the hypervisor 200.

In order to issue a notification indicating that the virtual machine 300 is in a state when the virtual machine 300 is capable of handling the physical or virtual interrupt (that is, in an active state) to the interrupt controller 100, a virtual machine ID which is an identifier of the virtual machine 300 may be written in the VMID register 102. The interrupt controller 100 recognizes the virtual machine 300 having the written virtual machine ID and transmits a physical (virtual) interrupt to the virtual machine 300.

Referring back to FIG. 2A, the hypervisor 200 provides a virtual computer hardware environment and adjusts an allocation of interrupts so that one or a plurality of virtual machines (or operating systems) handles the interrupt. In this case, the hypervisor 200 may also be referred to as a virtual machine monitor.

The hypervisor 200 may convert the physical interrupt (when IRQ_MODE bit=1) which is received from the interrupt controller 100 into a virtual interrupt. The hypervisor 200 may transmit the virtual interrupt to the virtual machine 300. In some exemplary embodiments, when the received physical interrupt is an interrupt for the hypervisor, the hypervisor 200 may handle the physical interrupt by itself using an interrupt handler (a second interrupt handler) corresponding to the physical interrupt.

The virtual machine 300 may handle the physical interrupt (IRQ_MODE bit=0) which is directly received from the interrupt controller 100 or the virtual interrupt (IRQ_MODE bit=1) which is received from the hypervisor 200 using an interrupt handler (third or first interrupt, respectively) corresponding to the interrupt. In this case, the virtual machine 300 may be, for example, a guest operating system (guest OS). The first interrupt handler and the third interrupt handler may be the same handler. However, in the following description, the first interrupt handler and the third interrupt handler may be distinguished from each other.

The virtual machine 300 may generate the above-described virtual machine ID (VMID). As described above, the virtual machine ID (VMID) is written in the VMID register 502, the interrupt controller 100 may recognize that the virtual machine 300 having the virtual machine ID is active.

The peripheral device/external device 2000 is an external input device including a keyboard, a mouse, a touch screen, and a network device. The peripheral device/external device 2000 may generate a signal which is received from a user or other device as a (physical) interrupt. The physical interrupt which is generated in the peripheral device/external device 2000 is transmitted to the interrupt controller 100.

FIG. 2B illustrates the system 1000A when an interrupt handling ends according to an exemplary embodiment of the present invention. An interrupt controller 100, a hypervisor 200, and a virtual machine 300 which are illustrated in FIG. 2B may perform an operation which will be described below, in addition to the operation which has been described with reference to FIG. 2A.

Referring to FIG. 2B, when a handling of a virtual interrupt (IRQ_MODE bit=1) is completed, the virtual machine 300 may write information of completion in an EOI register 101 of the interrupt controller 100. When the information of completion is written in the EOI register 101, the interrupt controller 100 recognizes the written information of completion to generate a maintenance interrupt and transmit the maintenance interrupt to the hypervisor 200. Next, when the hypervisor 200 receives the maintenance interrupt from the interrupt controller 100, the interrupt handling in the virtual machine 300 ends and the virtual machine 300 may go back to an operation before reception.

However, when the physical interrupt (IRQ_MODE bit=0) is directly received from the interrupt controller 100, even though the handling of the physical interrupt is completed, a separate maintenance interrupt is not necessary. Therefore, the virtual machine 300 does not write the information of completion in the EOI register 101 of the interrupt controller 100 so that the maintenance interrupt is not generated in the interrupt controller 100. In other words, when the virtual machine 300 directly receives the physical interrupt (IRQ_MODE bit=0) and completes the handling of the physical interrupt, the hypervisor 200 does not intervene.

A configuration of the system for handling an interrupt according to the first exemplary embodiment of the present invention is as described above. Hereinafter, a method for handling an interrupt according to the first exemplary embodiment will be described.

### [Method for Handling an Interrupt According to First Exemplary Embodiment]

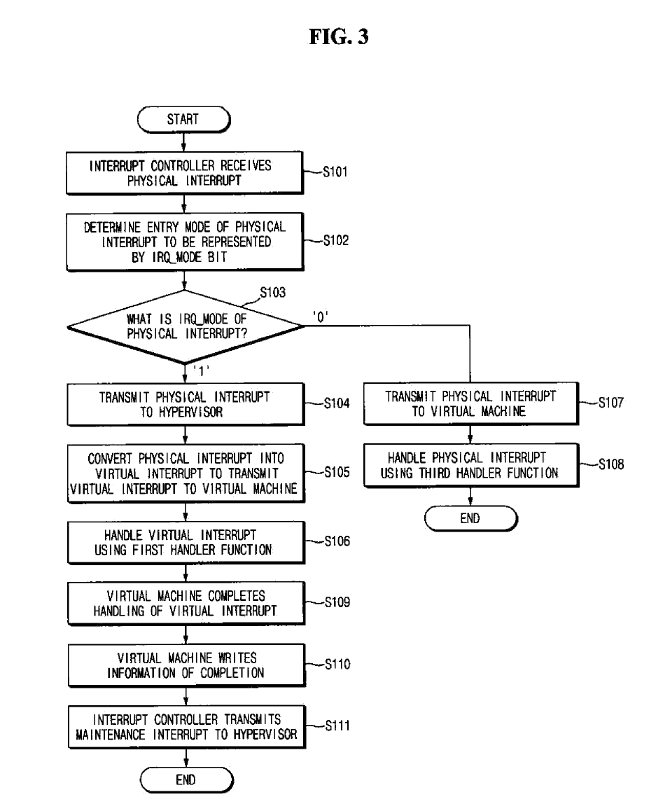

FIG. 3 illustrates a method for handling an interrupt according to a first exemplary embodiment of the present invention.

Referring to FIG. 3, a method for handling an interrupt according to a first exemplary embodiment of the present invention may include a step S101 of receiving, by an interrupt controller 100, a physical interrupt, a step S102 of determining, by the interrupt controller 100, an entry mode of the physical interrupt to be represented by a bit of IRQ_MODE, steps S103, S104, S107 of transmitting the physical interrupt to a hypervisor 200 or a virtual machine 300 based on a value of the bit of IRQ_MODE, a step S105 of converting, by the hypervisor 200, the physical interrupt into a virtual interrupt to transmit the virtual interrupt to the virtual machine 300, a step S106 of handling, by the virtual machine 300, the virtual interrupt using a first interrupt handler (function), a step S108 of handling, by the virtual machine 300, the physical interrupt using a third interrupt handler (function), a step S109 of completing, by the virtual machine 300, the handling of the virtual interrupt, a step S110 of writing, by the virtual machine 300, information of completion in an EOI register 101, and a step S111 of transmitting, by the interrupt controller 100, a maintenance interrupt to the hypervisor 200.

Hereinafter, it is assumed that the physical interrupt from the peripheral device/external device 2000 is an interrupt which is processible by the virtual machine 300 and it is described that the virtual machine 300 is active.

In step S101, the interrupt controller 100 receives the physical interrupt from the peripheral device/external device 2000. The physical interrupt is generated by a signal which is received from the user to the peripheral device/external device 2000.

In step S102, in the case of a physical interrupt which does not require an intervention of the hypervisor 200 in accordance with the characteristic of the physical interrupt, the interrupt controller 100 may set the entry mode of the interrupt, that is, bit of IRQ_MODE, to zero. In contrast, in the case of an actual interrupt which requires an intervention of the hypervisor 200 in accordance with the characteristic of the actual interrupt, the interrupt controller 100 may set the entry mode of the interrupt, that is, bit of IRQ_MODE, to one.

In step S103, the interrupt controller 100 determines whether a value of an IRQ_MODE bit is “0” or “1”. When the IRQ_MODE bit is “0”, the interrupt controller goes to step S107 and when the IRQ_MODE bit is “1”, the interrupt controller goes to step S104.

In step S104, since it is determined that the IRQ_MODE bit=“1” in step S103, the interrupt controller 100 transmits the physical interrupt to the hypervisor 200.

In step S105, the hypervisor 200 converts the received physical interrupt into a virtual interrupt and transmits the virtual interrupt to the virtual machine 300.

In step S106, the virtual machine 300 handles the received virtual interrupt using an interrupt handler (a first interrupt handler) corresponding to the received virtual interrupt.

In step S107, since it is determined that the IRQ_MODE bit=“I” in step S103, the interrupt controller 100 transmits the physical interrupt to the virtual machine 300.

In step S108, the virtual machine 300 handles the received physical interrupt using an interrupt handler (a third interrupt handler) corresponding to the received physical interrupt. When the handling of the physical interrupt is completed, the interrupt handling ends and the virtual machine 300 may go back to an operation before receiving the interrupt.

Continuously to step S106, in step S109, the virtual machine 300 may complete the handling of the virtual interrupt using the first interrupt handler (function).

In step S110, the virtual machine 300 writes the information of completion into an EOI register 101 of the interrupt controller 100.

In step S111, the interrupt controller 100 may transmit the maintenance interrupt to the hypervisor 200. When the hypervisor 200 receives the maintenance interrupt, the overall interrupt handling ends and thus the interrupt virtual machine 300 may go back to an operation before receiving the interrupt.

In addition to the steps, a step of writing, by the virtual machine 300, a virtual machine ID in the VMID register 102 of the interrupt controller 100 may be further included. By doing this, the interrupt controller 100 may recognize which virtual machine 300 is active and the interrupt controller 100 may cause a virtual machine 300 whose virtual machine ID is written to handle the physical (virtual) interrupt based on the recognition.

In the meantime, after the step S104, in some exemplary embodiments, the hypervisor 200 may handle the received virtual interrupt using its own interrupt handler (the second interrupt handler).

In some exemplary embodiments, after the steps S105 and S107, when the virtual machine 300 is already handling other physical (or virtual) interrupt, the received physical (or virtual) interrupt may be queued.

### Second Exemplary Embodiment

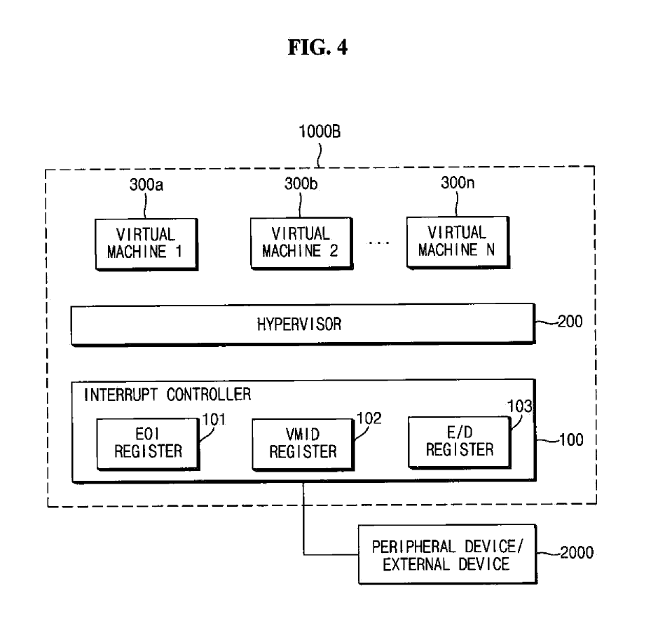

FIG. 4 illustrates a system 1000B for handling an interrupt at the time of interrupt handling according to a second exemplary embodiment of the present invention.

Referring to FIG. 4, a system 1000B for handling an interrupt according to a second exemplary embodiment of the present invention may comprise an interrupt controller 100, a hypervisor 200, and a plurality of virtual machines 1 to N (300a to 300n). Further, a peripheral device/external device 2000 is illustrated to transmit the interrupt, which is similar to the first exemplary embodiment and the interrupt controller 100 may further include an enable/disable register (E/D register) 103 in addition to an EOI register 101 and a VMID register 102, which is different from the first exemplary embodiment. The above configurations perform all operations described in the first exemplary embodiment so that redundancy description will be omitted.

The interrupt controller 100 may further include the E/D register 103 in addition to the EOI register 101 and the VMID register 102. The E/D register 103 may store information on interrupts which can be handled by the plurality of virtual machines 1 to N (300a to 300n) and such interrupt information may be set by an IRQ E/D (enable/disable) command when the system 1000B is initialized. For example, the E/D register 103 may store information as represented in the following Table 1.

TABLE 1

| | IRQ_0 | IRQ_1 | IRQ_2 | IRQ_3 | . . . | IRQ_8 |
|---|---|---|---|---|---|---|
| Virtual Machine 1 | E | E | D | E | . . . | D |
| Virtual Machine 2 | E | E | E | D | . . . | E |
| . . . | . . . | . . . | . . . | . . . | . . . | . . . |
| Virtual Machine N | D | D | E | E | . . . | E |

According to Table 1, a virtual machine 1 (300a) may handle the interrupt having an IRQ number such as IRQ_0, 1, 3 using an interrupt handler which is included in the virtual machine 1 (300a), a virtual machine 2 (300b) may handle the interrupt having an IRQ number such as IRQ_0, 1, 2, 8 using an interrupt handler which is included in a virtual machine 2 (300b), and a virtual machine N (300n) may handle the interrupt having an IRQ number such as IRQ_2, 3, 8 using an interrupt handler which is included in the virtual machine N (300n).

The interrupt controller 100 may transmit the received interrupt to the virtual machine which is activated by the hypervisor 200, among the virtual machines that can handle the received interrupt, by referring to the VMID register 102 and the E/D register 103. Though the virtual machine is able to handle the received interrupt, but the virtual machine is inactive, the interrupt controller 100 may queue the received interrupt until the virtual machine is activated by the hypervisor 200. Further, also when the virtual machine is handling other interrupt, the received interrupt may be queued.

In addition to the operation of the first exemplary embodiment, the hypervisor 200 controls the plurality of virtual machines 1 to N (300a to 300n) to be active/inactive or monitor the operations thoseof. The hypervisor 200 may switch the activation/inactivation of the plurality of virtual machines 1 to N (300a to 300n) at a predetermined interval of time, sequentially or in an arbitrary order. For example, the hypervisor 200 may switch the virtual machines in the order of the virtual machine 1 (300a)->the virtual machine 2 (300b)-> . . . ->the virtual machine N (300n)->the virtual machine 1 (300a) at every period of several to dozens of milliseconds to activate the virtual machine (inactivate other virtual machines). Further, the activation/inactivation of the virtual machines 1 to N (300a to 300n) may be switched by manipulation of a user.

### [Method for Handling an Interrupt According to Second Exemplary Embodiment]

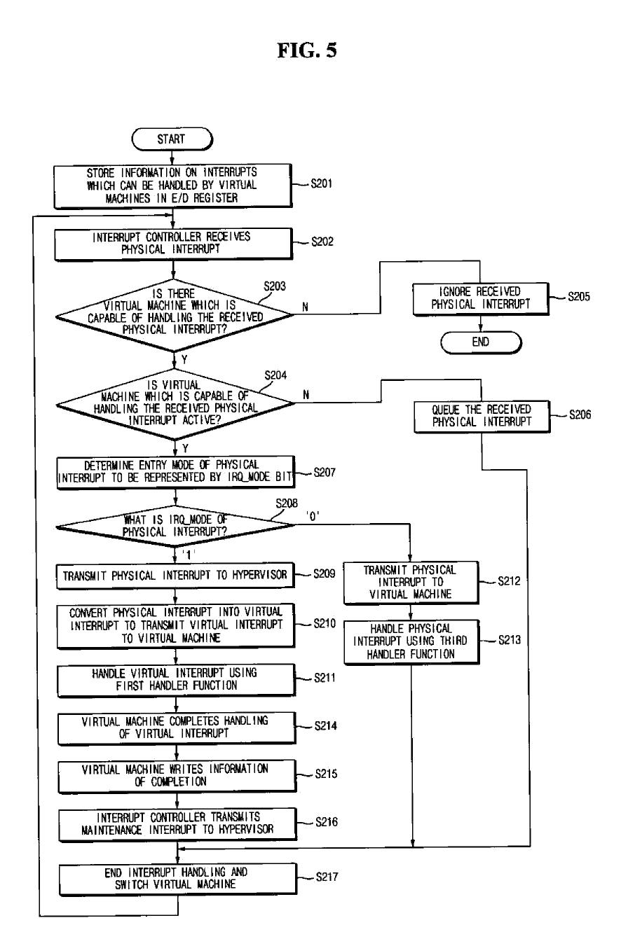

FIG. 5 illustrates a method for handling an interrupt according to a second exemplary embodiment of the present invention.

Referring to FIG. 5, a method for handling an interrupt according to a second exemplary embodiment of the present invention may include a step S201 of storing information on interrupts which may be handled by a plurality of virtual machines 1 to N (300a to 300n) in an E/D register of an interrupt controller 100, a step S202 of receiving, by the interrupt controller 100, a physical interrupt, a step S203 of determining, by the interrupt controller 100, whether there is a virtual machine which is capable of handling the received physical interrupt, a step S204 of determining, by the interrupt controller 100, whether at least one of the virtual machines which are capable of handling the received physical interrupts is active, a step S205 of, by the interrupt controller 100, ignoring the received physical interrupt and ending the interrupt handling when there is no virtual machine which is capable of handling the physical interrupt received in step S203, a step S206 of queuing the received physical interrupt when the virtual machine which is capable of handling the received physical interrupt is in active, a step S207 of determining, by the interrupt controller 100, an entry mode of the physical interrupt to be represented by a bit of an IRQ_MODE, a step S208 of determining a value of the bit of the IRQ_MODE, a step S209 of transmitting the physical interrupt to the hypervisor 200 when the value of the bit of the IRQ_MODE is “1”, a step S210 of converting, by the hypervisor 200, the physical interrupt into a virtual interrupt to transmit the virtual interrupt to the virtual machine 300, a step S211 of handling, by the virtual machine 300, the virtual machine using a first interrupt handler (function), a step S212 of transmitting the physical interrupt to the virtual machine 300 when the value of the bit of the IRQ_MODE which is determined in step S208 is “0”, a step S213 of handling, by the virtual machine 300, the physical interrupt using a third interrupt handler (function), a step S214 of completing, by the virtual machine 300, the handling of the virtual interrupt, continuously to step S211, a step S215 of writing, by the virtual machine 300, information of completion in an EOI register 101, a step S216 of transmitting, by the interrupt controller 100, a maintenance interrupt, and a step of ending the method after step S213 or step S216 and switching, by the hypervisor 200, the virtual machines in a predetermined order.

Hereinafter, steps S207 to S216 are the same as steps S102 to S111 of FIG. 3 so that redundant description will be omitted.

In step S201, information on interrupts which may be handled by the plurality of virtual machines 1 to N (300a to 300n) may be stored in the E/D register 103 of the interrupt controller 100. The information on the interrupts may be set by the IRQ E/D command when the system 1000B is initialized.

In step S202, the interrupt controller 100 receives the physical interrupt from the peripheral device/external device 2000. The physical interrupt is generated by a signal which is received from the user to the peripheral device/external device 2000.

In step S203, the interrupt controller 100 may determine whether there is a virtual machine which is capable of handling the received physical interrupt based on the interrupt information which is stored in the E/D register 103. When there is a virtual machine which is capable of handling the received physical interrupt, the interrupt controller 100 goes to step S204 and otherwise, the interrupt controller 100 goes to step S205.

In step S204, the interrupt controller 100 may determine whether at least one of virtual machines which are capable of handling the received physical interrupt is active by referring to the VMID register 102. When at least one of the virtual machines which are capable of handling the received physical interrupt is active, the interrupt controller 100 goes to step S207 and otherwise the interrupt controller 100 goes to step S206.

In step S205, when there is no virtual machine which is capable of handling the received physical interrupt based on the determination of step S204, the interrupt controller 100 ignores the physical interrupt and ends the handling of the interrupt.

Since the virtual machine which is capable of handling the received physical interrupt is not active in step S206, the interrupt controller 100 may queue the received physical interrupt and go to step S217.

Continuously to step S213 and step S216, in step S217, overall interrupt handling may end. When the handling ends, the hypervisor 200 may switch the activation/inactivation of the plurality of virtual machines 1 to N (300a to 300n) at a predetermined interval of time, sequentially or in an arbitrary order and goes back to step S202 to perform the above-described interrupt handling procedure again.

Similarly to the first exemplary embodiment, in addition to the steps, a step of writing, by the active virtual machine 300, a virtual machine ID in the VMID register 102 of the interrupt controller 100 may be further included. By doing this, the interrupt controller 100 may recognize which virtual machine 300 among the plurality of virtual machines is active and the interrupt controller 100 may cause a virtual machine whose virtual machine ID is written to handle the physical (virtual) interrupt based on the recognition.

In the meantime, after the step S210, in some exemplary embodiments, the hypervisor 200 may directly handle the received virtual interrupt using its own interrupt handler (the second interrupt handler).

In some exemplary embodiments, after the steps S210 and S212, when the virtual machine 300 is handling other physical (or virtual) interrupt, the received physical (or virtual) interrupt may be queued.

According to the interrupt controller 100, the systems 1000A, 1000B, and the method for handling an interrupt according to the exemplary embodiments of the present invention, not all the received physical interrupts are transmitted to the hypervisor 200 so that intervention of the hypervisor 200 may be reduced. Even at the time of ending the interrupt handling, the maintenance interrupt is generated in the interrupt controller 100 only when the handling of the virtual interrupt is completed, so that the intervention of the hypervisor 200 may be further reduced.

By doing this, the intervention of the hypervisor 200 is reasonably reduced so that a performance of a hardware, especially, an input/output performance may be improved.

The interrupt controller 100, the system 1000, and the method for handling an interrupt according to the exemplary embodiments of the present invention includes the VMID register 102 in the interrupt controller 100 and receives the virtual machine ID from the virtual machine 300 so that interrupt controller 100 may more efficiently perform scheduling of the interrupt handling of the virtual machine 300 without having intervention of the hypervisor 200.

### Modified Embodiment

### Discrimination Handle for IRQ Transmission

When a physical interrupt occurs, a virtual machine 300 which utilizes an IRQ may be discriminated by a VMID register 102 and an E/D register 103. In this case, in the case of an IRQ which is exclusively used by one virtual machine 300, a core in which the virtual machine 300 is executed is found and the IRQ is directly transmitted to the core and it is discriminated whether to be a hypervisor mode or a supervisor mode by referring to IRQ_MODE mentioned in the first exemplary embodiment to transmit the IRQ. Otherwise, the IRQ is queued for a while and the IRQ may be transmitted at a moment when the virtual machine 300 is active.

In the case of a shared IRQ, it needs to confirm which virtual machine 300 is a destination of the interrupt A virtual machine 300 which is currently active is confirmed and if there is a virtual machine 300 which is a recipient of the IRQ based thereon, the IRQ is transmitted to the virtual machine 300.

As described above, the present invention has been described with reference to the exemplary embodiments and various changes and modification become apparent to those skilled in the art without departing from a spirit and a scope of the present invention in the appended claims. Therefore, the spirit of the present invention needs to be interpreted by the appended claims and all equivalent modifications are included within the spirit of the present invention.

What is claimed is:

1. A system for handling an interrupt, comprising:
an interrupt controller;
a virtual machine; and
a hypervisor which controls activation of the virtual machine,
wherein the interrupt controller receives a physical interrupt from the outside and transmits the physical interrupt to the hypervisor or the virtual machine based on a characteristic of the physical interrupt,
the hypervisor converts the physical interrupt into a virtual interrupt to transmit the virtual interrupt to the virtual machine, and
the virtual machine handles the physical interrupt or the virtual interrupt using a first interrupt handler which is included in the virtual machine.

2. The system for handling an interrupt of claim 1, wherein the interrupt controller transmits the physical interrupt to the hypervisor or the virtual machine depending on whether the physical interrupt requires intervention of the hypervisor.

3. The system for handling an interrupt of claim 2, wherein the interrupt controller represents whether the physical interrupt requires intervention of the hypervisor using an interrupt request (IRQ)_MODE which is included in the physical interrupt.

4. The system for handling an interrupt of claim 1, wherein the hypervisor handles the physical interrupt using a second interrupt handler.

5. The system for handling an interrupt of claim 1, wherein the interrupt controller comprises an end of interrupt register (EOI register) and
when the handling of the virtual interrupt is completed, the virtual machine writes information of completion in the EOI register.

6. The system for handling an interrupt of claim 5, wherein when the information of completion is written in the EOI register, the interrupt controller transmits a maintenance interrupt to the hypervisor.

7. The system for handling an interrupt of claim 1, wherein the interrupt controller comprises a virtual machine identifier register,
when the virtual machine is activated by the hypervisor, the virtual machine writes the virtual machine ID of the virtual machine in the virtual machine ID register, and
the interrupt controller transmits the physical interrupt to the virtual machine whose virtual machine ID is written.

8. The system for handling an interrupt of claim 1, wherein a plurality of virtual machines is provided, and
the interrupt controller comprises an enable/disable register (E/D register) storing information on interrupts which can be handled by the plurality of virtual machines and transmits the received physical interrupt to a virtual machine which is capable of handling the received physical interrupt based on the information which is stored in the E/D register.

9. The system for handling an interrupt of claim 8, wherein the hypervisor switches the plurality of virtual machines in a predetermined order to be active,
the interrupt controller further comprises a virtual machine ID register,
the virtual machine which is switched to be active writes its own virtual machine ID in the virtual machine ID register, and
the interrupt controller transmits the received physical interrupt to a virtual machine which is capable of handling the received physical interrupt and whose virtual machine ID is written.

10. The system for handling an interrupt of claim 9, wherein when the virtual machine which is capable of handling the received physical interrupt and whose virtual machine ID is written is handling other physical interrupt or other virtual interrupt, the interrupt controller queues the received physical interrupt.

11. A method for handling an interrupt of an system which comprises an interrupt controller, a virtual machine, and a hypervisor which controls activation of the virtual machine, the method comprising:
receiving, by the interrupt controller, a physical interrupt from the outside;
transmitting, by the interrupt controller, the physical interrupt to the hypervisor or the virtual machine, based on a characteristic of the physical interrupt;
converting, by the hypervisor, the physical interrupt into a virtual interrupt to transmit the virtual interrupt to the virtual machine; and
handling, by the virtual machine, the physical interrupt or the virtual interrupt using a first interrupt handler which is included in the virtual machine.

12. The method for handling an interrupt of claim 11, wherein the transmitting, by the interrupt controller, the physical interrupt to the hypervisor or the virtual machine, based on a characteristic of the physical interrupt includes transmitting, by the interrupt controller, the physical interrupt to the hypervisor or the virtual machine depending on whether the physical interrupt requires intervention of the hypervisor.

13. The method for handling an interrupt of claim 12, further comprising:
representing whether the physical interrupt requires intervention of the hypervisor using an interrupt request (IRQ)_MODE which is included in the physical interrupt.

14. The method for handling an interrupt of claim 11, further comprising:
handling, by the hypervisor, the physical interrupt using a second interrupt handler.

15. The method for handling an interrupt of claim 11, further comprising:
writing, by the virtual machine, information of completion in an end of interrupt register (EOI register) which is comprised in the interrupt controller when the handling of the virtual interrupt is completed.

16. The method for handling an interrupt of claim 15, further comprising:
transmitting, by the interrupt controller, a maintenance interrupt to the hypervisor when the information of completion is written in the EOI register.

17. The method for handling an interrupt of claim 11, further comprising: writing, by the virtual machine, the virtual machine ID of the virtual machine in a virtual machine ID register which is comprised in the interrupt controller when the virtual machine is activated by the hypervisor; and
transmitting, by the interrupt controller, the physical interrupt to the virtual machine whose virtual machine ID is written.

18. The method for handling an interrupt of claim 11, wherein a plurality of virtual machines is provided and the interrupt controller further comprises an E/D register storing information on interrupts which can be handled by the plurality of virtual machines,
the method further comprising: transmitting, by the interrupt controller, the received physical interrupt to a virtual machine which is capable of handling the received physical interrupt, among the plurality of virtual machines, based on the information on the interrupts which is stored in the E/D register.

19. The method for handling an interrupt of claim 18, wherein the plurality of virtual machines are switched by the hypervisor in a predetermined order to be active,
the method further comprising:
writing, by the virtual machine which is switched to be active, its own virtual machine ID in the virtual machine ID register which is comprised in the interrupt controller, and
transmitting, by the interrupt controller, the received physical interrupt to a virtual machine which is capable of handling the received physical interrupt and whose virtual machine ID is written.

20. The method for handling an interrupt of claim 19, further comprising:
queuing, by the interrupt controller, the received physical interrupt when a virtual machine which is capable of handling the received physical interrupt and whose virtual machine ID is written is handling other physical interrupt or other virtual interrupt.
